(19) United States
(12) Patent Application Publication
(10) Pub. No.: US 2003/0074416 A1
(43) Pub. Date: Apr. 17, 2003

(54) Method of establishing a navigation mark for a web page

(76) Inventors: Cary Lee Bates, Rochester, MN (US); John Matthew Santosuosso, Rochester, MN (US)

Correspondence Address: Dugan & Dugan, 18 John Street, Tarrytown, NY, 10591, US

(21) Appl. No.: 09/965,330

(22) Filed: Sep. 27, 2001

(51) Int. Cl. G06F 15/16

(52) U.S. Cl. 709/217; 345/738

(57) ABSTRACT

While a web page is being displayed, the user is permitted to mark locations of interest within the web page. Data indicative of the mark locations is stored in association with a visited list entry for the web page. Subsequently, when a cursor is placed on a hyperlink for navigating to the web page, a thumbnail image of the web page pops up. The thumbnail image includes marks corresponding to the previously established location marks. By selecting one of the location marks, the user is allowed to navigate to the pre-selected location in the web page.

### FIELD OF THE INVENTION

This invention is concerned with data processing and is more particularly concerned with browsers for navigating computer networks.

### BACKGROUND OF THE INVENTION

Browsers are well known. Operating a browser enables a user of a personal computer connected to a computer network such as the Internet to navigate through the computer network and to search and retrieve files that may be of interest from other computers on the network. Commonly, such files are referred to as web pages when the network being navigated is the Internet.

Web pages come in many different sizes. Some web pages are so small that all of the information contained in the web page can be displayed simultaneously on the display of a personal computer. Other web pages are very large, comprising hundreds and/or thousands of pages of text and/or a similar number of images.

Navigating within a large web page can be difficult. A particular problem arises when a user retrieves a web page that he or she has previously visited and desires to return to a particular location in the page that was viewed on a previous visit. Frequently the user is required to reacquaint himself or herself with the layout of the web page and to spend considerable time attempting to navigate through the page to find the previously visited location that is of interest.

### SUMMARY OF THE INVENTION

According to a first aspect of the invention, a method of establishing a navigation mark with respect to a web page is provided. The method includes retrieving the web page from a server, establishing an entry for the retrieved web page in a visited list maintained at a web navigation tool, displaying the retrieved web page on the web navigation tool, using a pointing device to designate a location within the displayed web page, and storing an indication of the designated location in association with the entry for the retrieved web page.

According to a second aspect of the invention, a method of selecting a portion of a web page for display is provided. The method includes providing an indication of an address of the web page. In response to the indication of the address, a thumbnail representation of the web page is displayed, the thumbnail representation including a mark indicative of a particular location in the web page. The mark is selected, and in response to selection of the mark, the web page is retrieved from a server and the particular location in the web page is displayed.

The providing of the indication of the address of the web page may include placing a cursor in a locus of a hyperlink which corresponds to the web page.

According to a third aspect of the invention, a method of selecting a portion of a web page for display includes displaying an indicia that represents a web page and selecting a portion of the indicia. In response to selection of the portion of the indicia, the web page is retrieved from a server and a particular location in the web page is displayed. The particular location corresponds to the selected portion of the indicia.

Computer program products may be provided in accordance with these and other aspects of the invention. Each inventive program product may be carried by a medium readable by a computer (e.g., a carrier wave signal, a floppy disk, a hard drive, a random access memory, etc.).

By allowing a user to mark a particular location in a web page that is of interest and then subsequently to select the mark location as a part of a process of navigating to the web page, the present invention makes it possible to assist the user in finding particular locations within a web page that are of interest, and is especially useful in connection with navigation to particular locations within large or voluminous web pages.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 illustrates a cursor juxtaposed with a hyperlink;

FIG. 2 shows a thumbnail representation of a web page displayed in accordance with the invention in association with a hyperlink for the page, and also shows a navigation mark included in the thumbnail representation;

FIG. 3 is similar to FIG. 2, but showing a different navigation mark;

FIGS. 4A and 4B together represent a flow chart that illustrates a method for handling browser events in accordance with the present invention;

FIG. 5 is a representative display screen provided in accordance with the invention;

FIG. 6 is a schematic representation of a visited list provided in accordance with the invention;

FIG. 7 is another exemplary display screen provided in accordance with the invention;

FIG. 8 is a flow chart that represents processing carried out in connection with a “display navigation marks” block included in the flow chart of FIGS. 4A and B;

FIG. 9 is a schematic illustration of a thumbnail representation of a web page provided in accordance with an aspect of the invention;

FIG. 10 is a schematic illustration of a thumbnail representation of a web page provided in accordance with another aspect of the invention;

FIGS. 11A and 11B together represent a flow chart that illustrates an alternative process performed in connection with the block “display navigation marks” of the process of FIGS. 4A and 4B;

FIG. 12 shows a thumbnail representation of a web page displayed in conjunction with a hyperlink for the page in accordance with an alternative aspect of the invention; and

FIG. 13 is a simplified block diagram that illustrates a hardware environment in which the present invention may be applied.

### DETAILED DESCRIPTION OF PREFERRED EMBODIMENTS

Preferred embodiments of the invention will now be described with reference to the drawings.

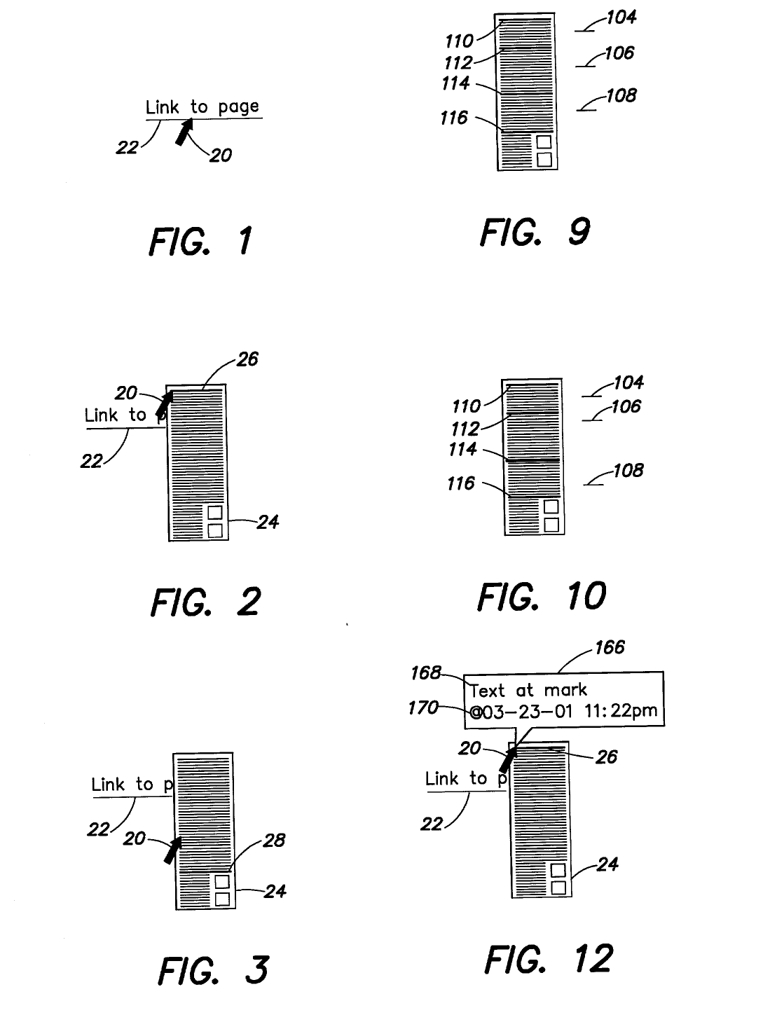

FIG. 1 shows a cursor 20, in the form of a pointer, juxtaposed with a hyperlink 22. In accordance with the invention, when the cursor 20 is positioned in the locus of the hyperlink 22, a thumbnail representation of the web page corresponding to the hyperlink appears, as illustrated in FIG. 2. In FIG. 2, reference numeral 24 indicates the thumbnail representation which has appeared. Reference numeral 26 indicates a location mark that is displayed as part of the thumbnail representation 24. In the example shown in FIG. 2, the location mark is at the top of the thumbnail representation and takes the form of a horizontal line. The location mark 26 may be, for example, displayed in a contrasting color such as red. As will be seen from the ensuing discussion, the location mark 26 represents a mark that the user has made in accordance with the invention on the web page which corresponds to the thumbnail representation 24 during a previous visit to the web page.

If the user moves the cursor 20 in the locus of the thumbnail representation 24 away from the location mark 26 and toward another location mark that is hidden in the display of FIG. 2, the resulting display is shown in FIG. 3. In FIG. 3, reference numeral 28 indicates the location mark that was previously hidden and that the cursor 20 is now in the vicinity of. It is to be understood that the formerly hidden, and now displayed location mark 28 was also established by the user during a previous visit to the web page represented by the thumbnail representation 24.

Referring again to FIG. 2, if the user selects the location mark 26 by, for example, clicking a mouse button when the cursor 20 is adjacent to the location mark 26, the web page corresponding to the thumbnail representation 24 is retrieved in accordance with conventional practice, but the particular portion of the web page displayed would correspond to the position of the location mark 26 in the thumbnail representation 24 (in this example the top of the web page would be displayed).

On the other hand, and referring again to FIG. 3, if the user selects the location mark 28, then the web page corresponding to the thumbnail representation 24 is retrieved, and the portion of the web page displayed upon retrieval of the web page is the portion which corresponds to the location in the web page indicated by the location mark 28.

The thumbnail representation 24 may also include a scroll bar (not shown) which permits the thumbnail representation 24 to be scrollable. This would be particularly helpful when the thumbnail representation 24 corresponds to a very voluminous web page.

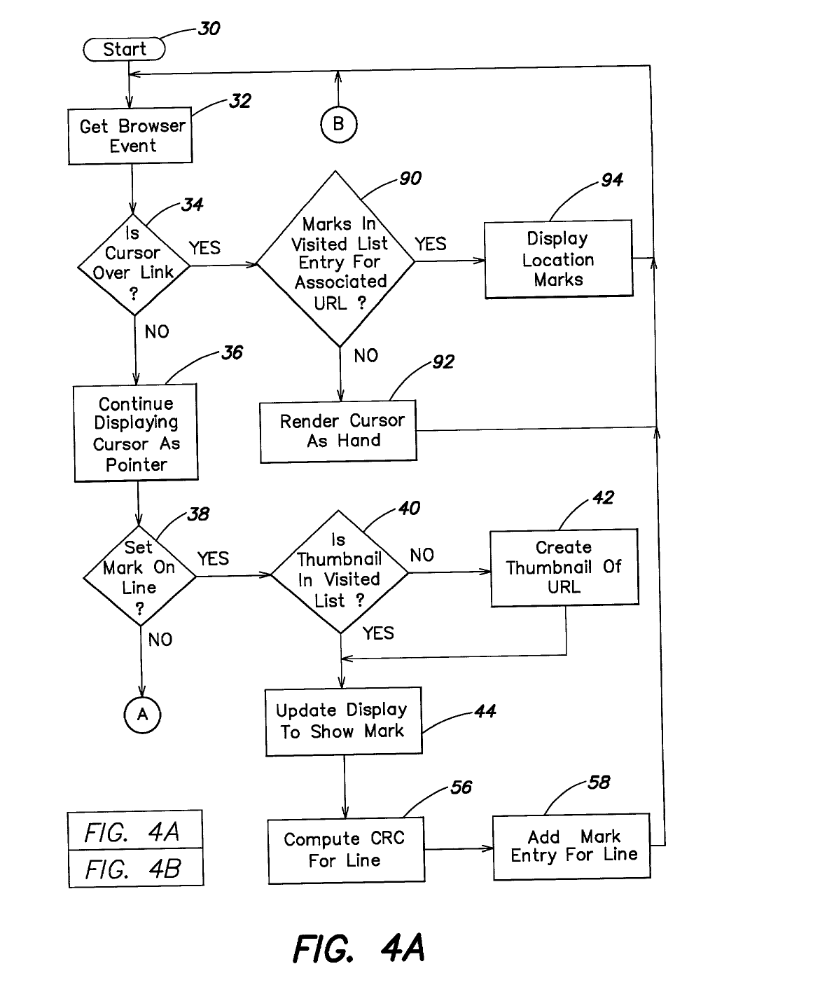

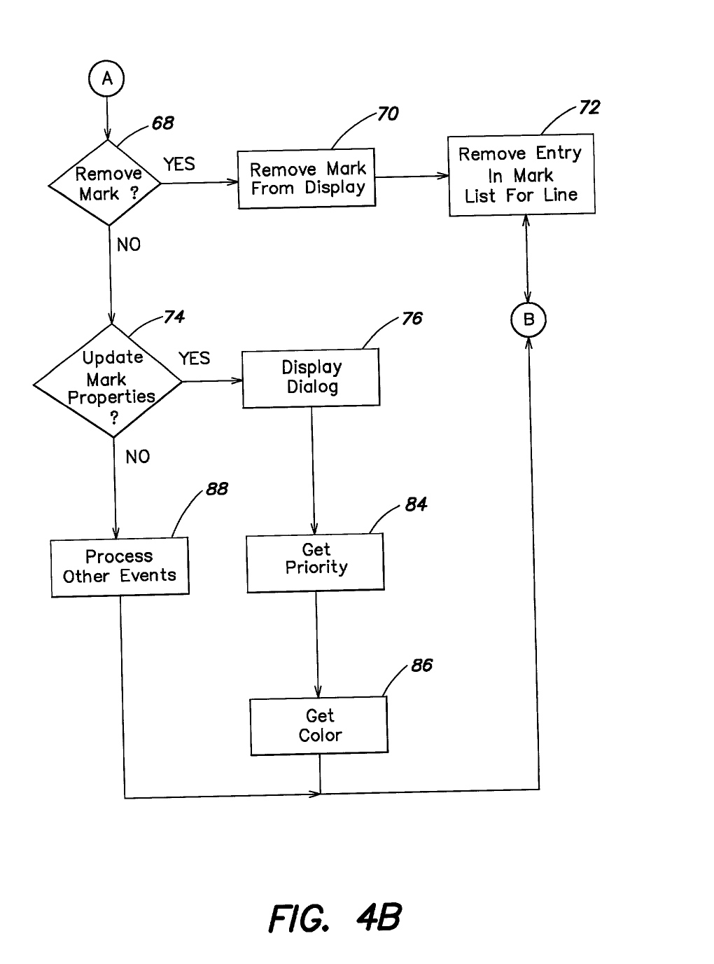

There will now be described, with reference to FIGS. 4A and 4B, a method performed in accordance with the invention. The method of FIGS. 4A and 4B may be performed by a web navigation tool as part of a web browser application, or as a plug-in for a web browser application. As used herein, a web navigation tool may include a computer (e.g., a mainframe, desktop, laptop, handheld or any other type of computer), a personal digital assistant (PDA), a cellular telephone having web browser capabilities or any other device having web browser capabilities.

The flow chart of FIGS. 4A and 4B begins with a start block 30, and then proceeds to a block 32, at which a browser event occurs. Following block 32 is a decision block 34, at which it is determined whether a cursor is positioned over a hyperlink. If not, block 36 follows, at which the web navigation tool continues to display the cursor as a pointer.

Following block 36 is decision block 38. At decision block 38 it is determined whether the user has taken an action to establish a location mark at a particular point in a web page that is being displayed. If a positive determination is made at decision block 38, then decision block 40 follows. At decision block 40 it is determined whether a thumbnail representation has been created for the web page that is currently being displayed. If such is not the case, then block 42 follows, at which a thumbnail representation is created for the web page.

Following block 42, or immediately following block 40 if a negative determination is made at block 40, is block 44. At block 44, the display of the web page is updated to show a location mark at the point indicated by the user.

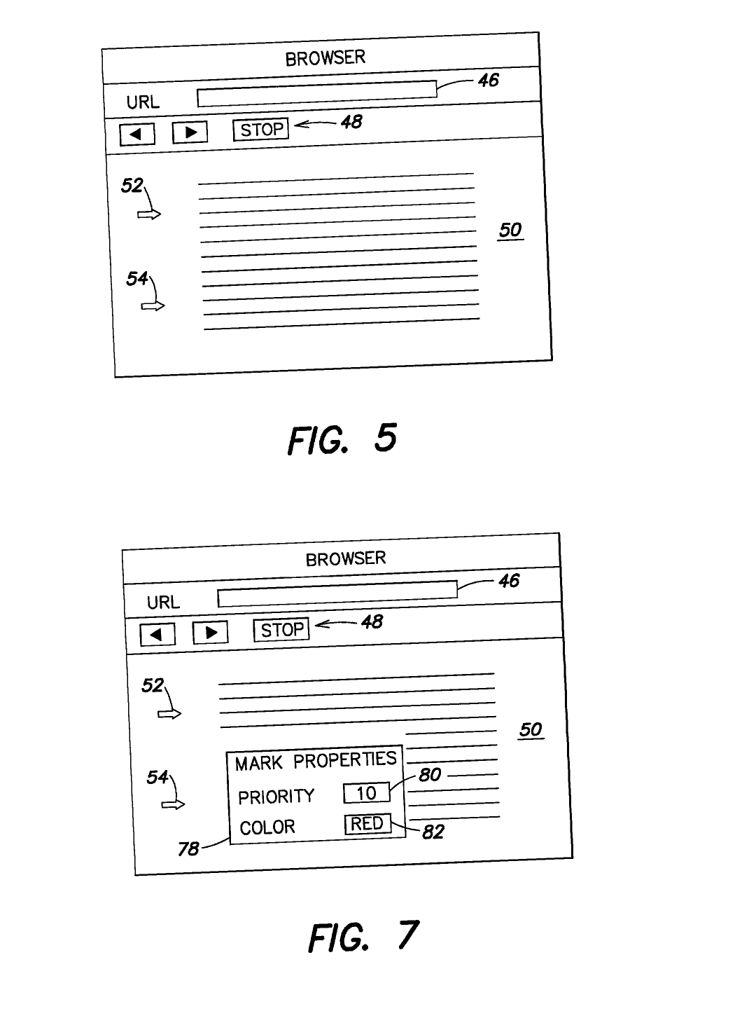

FIG. 5 is a representative screen display provided in accordance with the invention. FIG. 5 shows a display of a web page and also shows location marks that have been established by the user pursuant to blocks 38 and 44. In FIG. 5, field 46 is a conventional field in which the URL (uniform resource locator) corresponding to the currently visited web site is displayed. (To simplify the drawing, no URL is actually shown in field 46). Then, at 48, conventional function buttons are displayed, such as “back”, “forward”, and “stop”. In field 50 the text (and if applicable also images) of the retrieved web page are displayed. In addition, location marks 52 and 54 are displayed to indicate locations in the web page at which the user has established location marks in accordance with the invention. The location marks 52 and 54 are examples of the marks displayed pursuant to block 44 (FIG. 4A). Although marks 52 and 54 are shown in the form of arrows, it is to be understood that any other symbol may be utilized to indicate the position of a location mark that has been established by the user.

The actions taken by the user to establish a location mark may include, for example, positioning a cursor at a point in the displayed web page at which the user desires to establish a location mark, and then either clicking a mouse button or actuating a function key on the keyboard.

Referring once more to FIG. 4A, block 56 follows block 44. At block 56 a cyclic redundancy check (CRC) computation is made for the line in the displayed web page at which the location mark is to be set. Then, at block 58, an entry for the location mark to be established is added to the visited list.

As will be understood by those who are skilled in the art, the “visited list” is a list maintained by the web navigation tool of all web pages that the web navigation tool has retrieved. In accordance with the invention, the conventional visited list is modified by including therein data indicative of location marks and thumbnail representations for web pages included in the visited list.

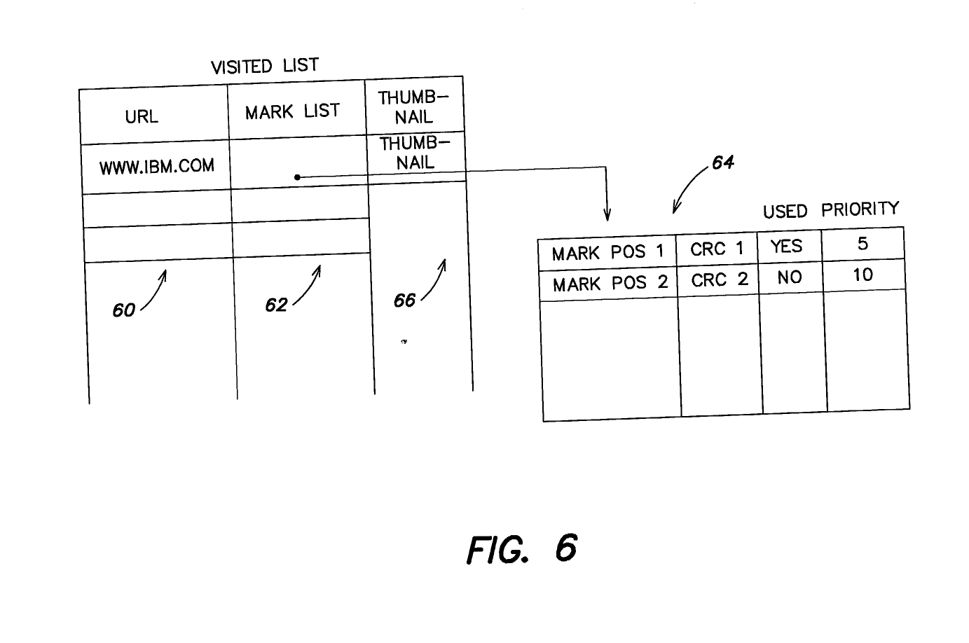

A visited list that has been modified in accordance with the invention is illustrated in FIG. 6. In a first column 60 in FIG. 6, the URL's of the visited web pages are listed. Then, in a second column 62, there is stored data indicative of location marks that have been established for the visited web pages. If no location marks have been established for a visited web page, then the corresponding entry under column 62 may be blank. However, if one or more location marks have been established for a visited web page, then column 62 may contain information like that shown in inset 64. For example, there may be stored for each established location mark a mark position, a CRC code, an indication as to whether the location mark has been used, and an indication of the priority of the location mark. The significance of the data in regard to whether the mark has been used and its priority will be explained below. The mark position information may indicate the location of the mark in the web page by means of an offset from the start of the page, or by reference to an intra-page link. Alternatively the mark position may be indicated by the name of the HTML object in the page or by any tag in the page or by a paragraph number. The mark position may alternatively be indicated by a text string or a header.

In a third column 66 of the visited list, there may be stored pointers to the thumbnail representations that have been established for the visited web pages for which at least one location mark has been established.

Referring once more to FIG. 4A, if it is determined at decision block 38 that the user has not taken action to establish a location mark on a currently displayed web page, then decision block 68 (FIG. 4B) follows. At decision block 68 it is determined whether the user has taken an action to remove a location mark from a currently displayed web page. Such an action on the part of the user may entail positioning a cursor on a previously-established location mark in the currently displayed web page, and clicking a mouse button or actuating a function key on the keyboard to indicate that the location mark is to be removed. For example, clicking a left mouse button may indicate establishment of a location mark, and clicking a right mouse button may indicate removal of a location mark.

If a positive determination is made at block 68, then block 70 follows. At block 70 the location mark in question is removed from the display, and then block 72 follows. At block 72 the corresponding entry for the mark to be removed is deleted from the mark list column 62 (FIG. 6) of the visited list.

Referring again to FIG. 4B, if a negative determination is made at block 68, then a decision block 74 follows. At decision block 74 it is determined whether the user has taken an action to indicate a desire to update the properties of a previously established location mark. Such an indication on the part of the user may include positioning the cursor on the location mark in question, and actuating an appropriate one of the function keys on the keyboard.

If a positive determination is made at block 74, then block 76 follows. At block 76 a suitable dialog box is displayed in conjunction with the location mark in question to allow the user to update the properties of the location mark. Such a display is shown in FIG. 7. It will be noted that FIG. 7 is similar to FIG. 5, with the addition of dialog box 78 which is displayed in conjunction with location mark 54. It will be seen that dialog box 78 includes a field 80 at which the “priority” accorded to the location mark in question may be adjusted. The significance of the “priority” will be explained below. In addition, dialog box 78 includes a field 82 at which the color of the corresponding location mark in the thumbnail image may be adjusted. Adjustment of the fields 80 and 82 may be performed, for example, by having those fields include pull down menus.

Referring once more to FIG. 4B, blocks 84 and 86 follow block 76, and respectively correspond to setting or adjustment of the properties of the location mark in question.

Referring once more to decision block 74, if a negative determination is made at that decision block, then block 88 follows. Block 88 represents processing of any type of browser event that may have occurred at block 32 (FIG. 4A) other than the events that have previously been described herein in connection with FIGS. 4A and 4B.

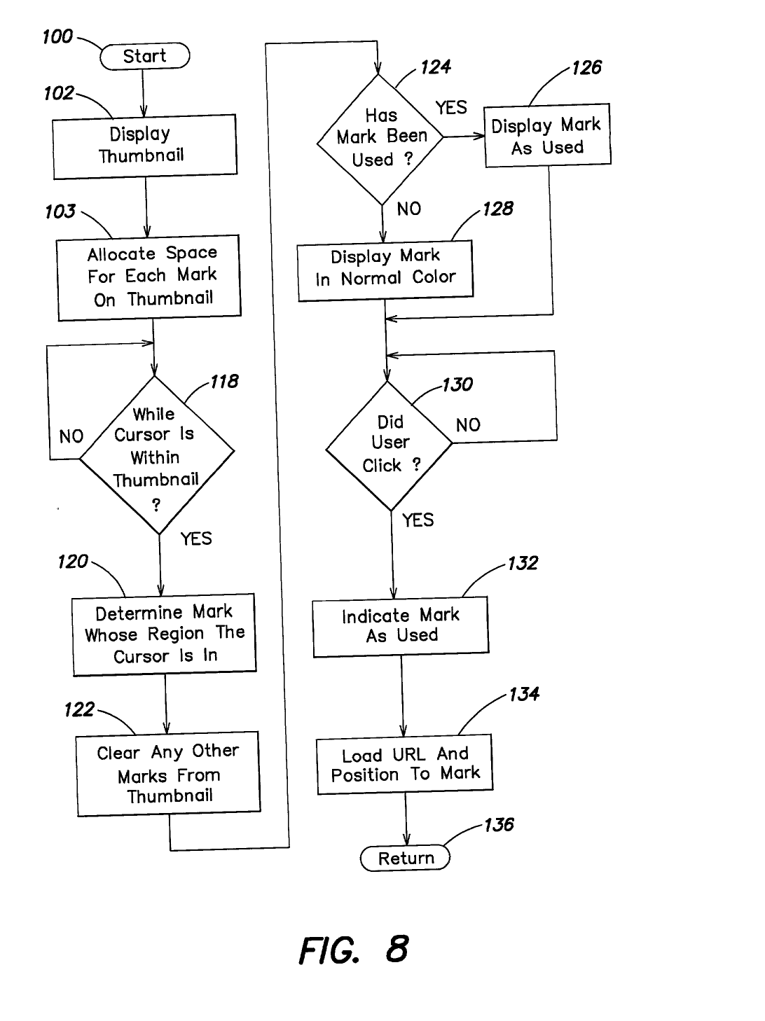

Referring once more to FIG. 4A, if a positive determination is made at decision block 34 (i.e., if it is determined that the cursor is over a hyperlink), then decision block 90 follows. At block 90, the visited list (FIG. 6) is accessed, and it is determined for the URL corresponding to the hyperlink in question whether any location marks are listed for the URL in question. If not, the cursor is rendered as a “hand” icon (block 92), and the process returns to block 32. Otherwise, i.e. if a positive determination is made at block 90, then block 94 follows. At block 94 one or more location marks are displayed as part of a thumbnail representation of the web page in question. FIG. 8 is a flow chart that illustrates details of processing carried out in connection with block 94.

The process of FIG. 8 starts at 100 and proceeds to block 102. At block 102 the thumbnail representation of the web page in question is displayed. Then, at block 103, space is allocated in the thumbnail representation for each location mark. FIG. 9 is a schematic representation of how space may be allocated among location marks in accordance with a first alternative embodiment of the invention. According to the alternative embodiment schematically illustrated in FIG. 9, dividing points 104, 106, 108 are positioned equidistant between adjacent location marks. That is, dividing point 104 is positioned equidistant between location marks 110 and 112; dividing point 106 is located equidistant between location marks 112 and 114; and dividing point 108 is located equidistant between location marks 114 and 116. It is to be understood that each dividing point is indicative of a point at which a region corresponding to one adjoining location mark begins and the region corresponding to the other adjoining mark ends.

FIG. 10 is a schematic illustration of allocation of space to location marks according to a second alternative embodiment of the invention. According to this embodiment, location marks having higher priority are allocated more space than marks having lower priority. In the example shown in FIG. 10, location mark 114 is a high priority mark, and the other marks 110, 112, 116 are low priority marks. It will be observed that dividing points 106 and 108 have been pushed away from location mark 114 such that dividing point 106 is closer to location mark 112 than to location mark 114, and dividing point 108 is closer to location mark 116 than to location mark 114. Consequently, the higher priority location mark 114 is allocated a relatively large region between dividing points 106 and 108, while the regions corresponding to the location marks 112 and 116 are reduced in favor of the region of location mark 114. Because the region of high priority mark 114 is large relative to the regions of the other marks, it is easier to find and actuate location mark 114, and mark 114 is more likely to be displayed as part of the thumbnail representation.

As an alternative or in addition to allocating enhanced regions to high priority location marks, high priority location marks may be displayed differently from low priority marks. For example, high priority marks may be displayed brighter and/or wider and/or with a more prominent color than low priority marks.

Referring again to FIG. 8, following block 103 is a decision block 118 at which it is determined whether the cursor is located within the thumbnail representation. When such is the case, block 120 follows block 118. At block 120, it is determined what location mark corresponds to the region in which the cursor is located. Then, at block 122, other marks (i.e., marks for which the cursor is not located in the mark's region) are suppressed. Following block 122 is a decision block 124. At block 124 it is determined whether the mark in whose region the cursor is located has previously been used (i.e., it is determined whether that mark has previously been used to navigate to the corresponding location in the web page). If a positive determination is made at block 124, then the mark is displayed in a manner that indicates that it has been previously used (block 126). If a negative determination is made at block 124, then block 128 follows block 124. At block 128 the mark in whose region the cursor is located is displayed in its “normal” color, i.e., in a color indicating that the mark has not been previously used. For example, a mark that has been used may be displayed in a gray color and a mark that has not been used may be displayed in a red color.

Following block 126 or block 128, as the case may be, is a decision block 130. At decision block 130 it is determined whether the user has clicked an appropriate mouse button to select the displayed mark.

If such is the case, block 132 follows block 130. At block 132 the entry for the mark in the visited list is changed (inset 64, FIG. 6) to indicate that the mark in question has been used. Then, at block 134, the URL corresponding to the link is loaded, the web page in question is retrieved, and the location in the web page corresponding to the selected location mark is displayed. The process of FIG. 8 then returns as indicated at 136.

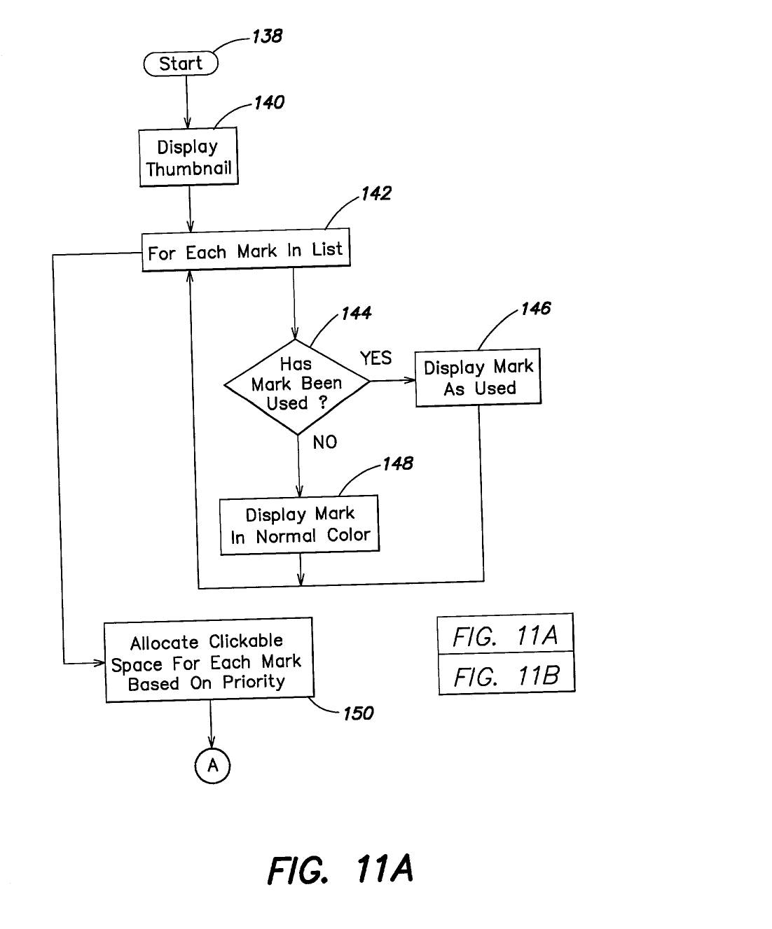

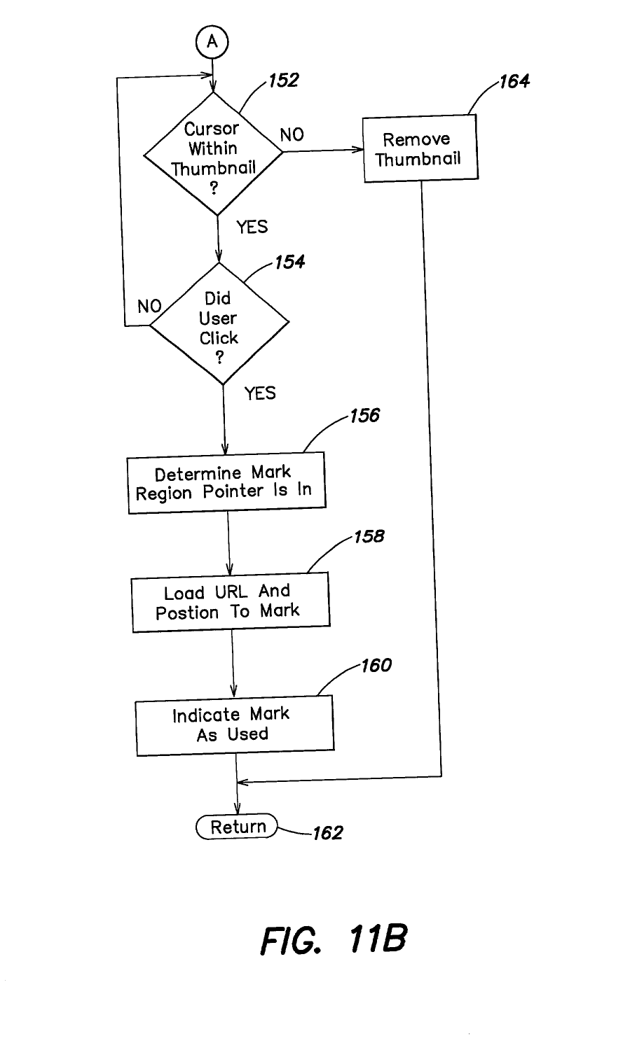

The process of FIG. 8 corresponds to an embodiment of the invention in which only one location mark is displayed at any one time in the thumbnail representation. However, it is also contemplated to simultaneously display in the thumbnail representation all of the location marks corresponding to the web page represented by the thumbnail representation. FIGS. 11A and 11B together represent a flow chart which illustrates the embodiment in which all location marks are simultaneously displayed. The process of FIGS. 11A and 11B starts at block 138 and proceeds to block 140, at which the thumbnail representation is displayed. Following block 140 is block 142, which indicates a loop performed with respect to each location mark stored in the visited list with respect to the web page in question. The loop represented by block 142 begins with a decision block 144, at which it is determined whether the mark in question has previously been used. If so, the mark is displayed as used (block 146). Otherwise, the mark is displayed in its normal color (block 148).

Following the displaying of all the location marks, as represented by blocks 142-148, is a block 150. At block 150 the regions around the location marks are allocated. This may be done on the basis of priority, as described in connection with FIG. 10, or the regions may be divided at points equidistant between adjacent location marks, as illustrated in FIG. 9. The manner in which the location marks are displayed may depend on their priority, as discussed above.

Following block 150 is decision block 152 (FIG. 11B). At block 152, it is determined whether the cursor remains within the locus of the thumbnail representation. If so, it is next determined, at decision block 154, whether the user has clicked the appropriate mouse button to indicate selection of a location mark. If this has occurred, then block 156 follows. At block 156 it is determined which mark corresponds to the region in which the cursor is located. Based on this determination, the URL corresponding to the web page is loaded, the web page is retrieved, and the location in the web page corresponding to the selected mark is displayed (block 158). In addition, the visited list entry for the mark in question is updated, if necessary, to indicate that the mark in question has been used (block 160). The process of FIGS. 11A and 11B then returns, as indicated at 162. Considering again decision block 152, if it is determined in that decision block that the cursor is no longer within the thumbnail representation, then the thumbnail representation is removed from the display (block 164).

FIG. 12 illustrates another manner of displaying a thumbnail representation that may be provided in accordance with an alternative aspect of the invention. According to this aspect of the invention, a pop up box 166 is displayed with respect to a location mark 26 when the cursor 20 is positioned in the region corresponding to the location mark 26. The pop up box 166 includes a display of text 168 that corresponds to the text in the web page at the location in the web page of the mark 126. The pop up box 166 may also display, as indicated at 170, the date and time at which the user last visited the particular location in the web page in question.

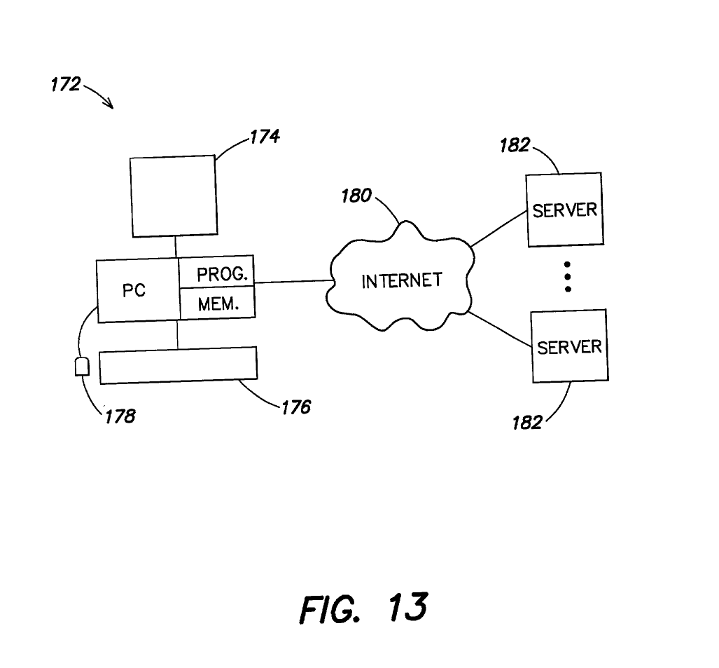

FIG. 13 is a simplified block diagram representation of an exemplary hardware environment in which the present invention may be applied. In FIG. 13, reference numeral 172 represents a personal computer (e.g., a desktop, laptop or handheld computer) which may run a browser that includes the functions described herein. It will be understood that the present invention may be similarly employed with any web navigation tool.

As is conventional, the personal computer 172 includes a monitor 174, a keyboard 176 and a mouse 178. As is also conventional, the personal computer 172 also includes a processor and memory, which are not separately shown. The memory may include RAM and a hard drive or other mass storage. The personal computer 172 is selectively connectable to the Internet 180. Via the Internet 180 the personal computer 172 may selectively access servers 182 to download web pages therefrom.

It will be appreciated that web pages may be modified from time to time. Consequently, a portion of a web page that has been marked by a user in accordance with the invention may be removed. If this occurs, an attempt to navigate to that portion of the web page will fail. The software of the present invention may then operate to remove the corresponding location mark information from the visited list. Alternatively, all location mark information for that web page may be removed.

The functions provided by the present invention allow a user to mark particular locations of interest in a web page that is being viewed. Subsequent actions to access the web page may use the marks to navigate to the particular locations of interest. In this way, users are aided in their efforts to navigate to particular points in web sites. The invention is of particular value with respect to navigating large, complex web sites. Among other useful applications, the present invention may aid a user in returning to particular portions of on-line manuals and the like.

The foregoing description discloses only the preferred embodiments of the invention; modifications of the above disclosed apparatus and methods which fall within the scope of the invention will be readily apparent to those of ordinary skill in the art. For example, in the exemplary embodiments described above, the thumbnail representation of the web page in question appeared when a cursor was positioned over a hyperlink for the web page. As an alternative, however, it is contemplated to have a thumbnail representation for a web page appear when a URL for the web page is entered in a suitable field displayed by a browser.

Process steps have been set forth in a certain order in the above description of the invention, but it is contemplated to modify the order of the process steps. The process steps may be performed in any order that is practicable.

While the present invention has been disclosed in connection with preferred embodiments thereof, it should be understood that other embodiments may fall within the spirit and scope of the invention, as defined by the following claims.

The invention claimed is:

1. A method of establishing a navigation mark with respect to a web page, comprising the steps of:
retrieving the web page from a server;
establishing an entry for the retrieved web page in a visited list maintained at a web navigation tool;
displaying the retrieved web page on the web navigation tool;
using a pointing device to designate a location within the displayed web page; and
storing an indication of the designated location in association with the entry for the retrieved web page in the visited list.

2. The method of claim 1, wherein the indication of the designated location includes data indicative of an offset from a beginning of the web page.

3. The method of claim 1, wherein the indication of the designated location includes data indicative of an HTML object included in the web page.

4. The method of claim 1, wherein the indication of the designated location includes data indicative of a paragraph of the web page.

5. The method of claim 1, wherein the indication of the designated location includes data indicative of a tag included in the web page.

6. The method of claim 1, wherein the indication of the designated location includes data indicative of a text string at the designated location.

7. The method of claim 1, wherein the pointing device is a mouse.

8. A method of selecting a portion of a web page for display, comprising the steps of:
(a) providing an indication of an address of the web page;
(b) in response to step (a), displaying a thumbnail representation of the web page, the thumbnail representation including a mark indicative of a particular location in the web page;
(c) selecting the mark; and
(d) in response to step (c), retrieving the web page from a server and displaying the particular location in the web page.

9. The method of claim 8, wherein step (a) includes placing a cursor in a locus of a hyperlink which corresponds to the web page.

10. The method of claim 8, wherein step (c) includes using a pointing device.

11. The method of claim 10, wherein step (c) includes clicking a mouse button.

12. A method of selecting a portion of a web page for display, comprising the steps of:
displaying an indicia that represents a web page;
selecting a portion of the indicia;
in response to the selection of the portion of the indicia, retrieving the web page from a server and displaying a particular location in the web page, wherein the particular location corresponds to the selected portion of the indicia.

13. The method of claim 12, wherein the indicia includes a thumbnail representation of the web page.

14. The method of claim 13, wherein the selected portion of the indicia is a location mark included in the thumbnail representation of the web page.

15. Apparatus for establishing a navigation mark with respect to a web page, comprising:
a memory; and
a processor connected to the memory and programmed to:
retrieve the web page from a server;
establish an entry for the retrieved web page in a visited list;
cause the retrieved web page to be displayed;
receive a signal from a pointing device to designate a location within the displayed web page; and
store an indication of the designated location in association with the entry for the retrieved web page in the visited list.

16. Apparatus for selecting a portion of a web page for display, comprising:
a memory; and
a processor connected to the memory and programmed to:
receive a signal indicating an address of the web page;
in response to the received signal, cause a thumbnail representation of the web page to be displayed, the thumbnail representation including a mark indicative of a particular location in the web page;
receive a signal selecting the mark; and
in response to the received mark selection signal, retrieve the web page from a server and cause to be displayed the particular location in the web page.

17. Apparatus for selecting a portion of a web page for display, comprising:
a memory; and
a processor connected to the memory and programmed to:
cause to be displayed an indicia that represents a web page;
receive a signal indicating selection of a portion of the indicia;
in response to the received signal, retrieve the web page from a server and cause to be displayed a particular location in the web page, wherein the particular location corresponds to the selected portion of the indicia.

18. The apparatus of claim 17, wherein the displayed indicia includes a thumbnail representation of the web page.

19. The apparatus of claim 18, wherein the selected portion of the indicia is a location mark included in the thumbnail representation of the web page.

20. A computer program product comprising:
a medium readable by a computer, the computer readable medium having computer program code adapted to:
retrieve a web page from a server;
establish an entry for the retrieved web page in a visited list;
cause the retrieved web page to be displayed;
receive a signal from a pointing device to designate a location within the displayed web page; and
store an indication of the designated location in association with the entry for the retrieved web page in the visited list.

21. A computer program product comprising:
a medium readable by a computer, the computer readable medium having computer program code adapted to:
receive a signal indicating an address of a web page;
in response to the received signal, cause a thumbnail representation of the web page to be displayed, the thumbnail representation including a mark indicative of a particular location in the web page;
receive a signal selecting the mark; and
in response to the received mark selection signal, retrieve the web page from a server and cause to be displayed the particular location in the web page.

22. A computer program product comprising:
a medium readable by a computer, the computer readable medium having computer program code adapted to:
cause to be displayed an indicia that represents a web page;
receive a signal indicating selection of a portion of the indicia;
in response to the received signal, retrieve the web page from a server and cause to be displayed a particular location in the web page, wherein the particular location corresponds to the selected portion of the indicia.
